(19) United States
(12) Patent Application Publication
(10) Pub. No.: US 2026/0342594 A1
(43) Pub. Date: Oct. 29, 2026

(54) SYSTEMS AND METHODS FOR COMMAND-BASED VEHICULAR CONTROL AND COMPLIANCE LOGGING

(71) Applicant: D3 DYNASTY HOLDINGS INC., LEWES, DE (US)

(72) Inventor: DENZELL MICHAEL BROWN, LEWES, DE (US)

(21) Appl. No.: 19/347,712

(22) Filed: Oct. 2, 2025

Related U.S. Application Data
(60) Provisional application No. 63/795,567, filed on Apr. 27, 2025.

(51) Int. Cl. H04L 9/32; G06Q 30/018

(52) U.S. Cl. CPC H04L 9/3263; G06Q 30/018

(57) ABSTRACT

Embodiments of the present disclosure disclose methods and systems for command-based vehicular control and compliance logging is disclosed. The method includes receiving a command packet transmitted from at least one authorized command source. The method includes authenticating the command packet and a set of authentication parameters associated with the command packet based on validating an authentication identifier associated with the command packet using a public key infrastructure defined for the command packet. Upon successful authentication of the command packet and the set of authentication parameters, the method includes determining a priority level of the command packet received from each authorized command source of the at least one authorized command source based on a predefined hierarchy of issuing authorities. The method includes facilitating execution of vehicular control action associated with the command packet associated with each authorized command source based on the determined priority level of the each authorization source.

### TECHNICAL FIELD

The present disclosure relates to intelligent transportation systems and automated vehicle response mechanisms, and more particularly to systems and methods for receiving and processing external control commands and modifying vehicular behavior accordingly, and generating compliance records for logging and auditing purposes.

### BACKGROUND

Advancements in transportation technology have led to the widespread development and deployment of autonomous and semi-autonomous vehicles. Such vehicles integrate sensors, artificial intelligence, and communication systems to reduce human involvement in driving tasks and improve overall road safety, traffic efficiency, and operational convenience. Despite these advancements, current vehicle ecosystems remain largely reactive and self-contained. While modern vehicles are capable of sensing their surroundings and navigating with minimal human input, they often lack meaningful interoperability with external traffic management entities, public safety agencies, or command authorities. This disconnect is particularly evident in situations involving emergency situations, where vehicle responsiveness to centralized directives is either absent or inconsistently applied.

Further, existing traffic enforcement and emergency management processes are still grounded in traditional methods that require drivers to interpret and respond to visual, auditory, or gestural signals from officers or authorities. This manual dependency creates a range of challenges, including delayed compliance, misinterpretation of instructions, and increased risk during high-stress or time-sensitive operations. These limitations become more pronounced in scenarios involving multiple jurisdictions, conflicting directives, or complex traffic environments.

Therefore, there exists a need for improved systems and methods for managing the inheritance of resources (e.g., assets, liabilities, and so on) to overcome the above-mentioned difficulties.

### SUMMARY

Various embodiments of the present disclosure provide methods and systems for command-based vehicular control and compliance logging.

In an embodiment, a computer-implemented method is disclosed. The computer-implemented method performed by a system includes receiving a command packet transmitted from at least one authorized command source via a communication channel. The method includes authenticating the command packet and a set of authentication parameters associated with the command packet based at least on validating an authentication identifier associated with the command packet using a public key infrastructure defined for the command packet. Upon successful authentication of the command packet and the set of authentication parameters, the method includes determining a priority level of the command packet received from each authorized command source of the at least one authorized command source based on a predefined hierarchy of issuing authorities. Further, the method includes facilitating execution of at least one vehicular control action associated with the command packet associated with each authorized command source based at least on the determined priority level of the each authorization source. The at least one vehicular control action is executed by a vehicle equipped with the system. The method further includes generatinga compliance log including a cryptographic record of the determined priority level, the at least one vehicular control action, the set of authentication parameters, vehicle response, and contextual telemetry. Furthermore, the method includes storing the compliance log in a database associated with the system.

In another embodiment, a system is disclosed. The system includes a communication interface, a memory including executable instructions, anda processor communicably coupled to the communication interface and the memory. The processor is configured to cause the system to at least receive a command packet transmitted from at least one authorized command source via a communication channel. The system is configured to authenticate the command packet and a set of authentication parameters associated with the command packet based at least on validating an authentication identifier associated with the command packet using a public key infrastructure defined for the command packet. Upon successful authentication of the command packet and the set of authentication parameters, the system is configured to determine a priority level of the command packet received from each authorized command source of the at least one authorized command source based on a predefined hierarchy of issuing authorities. The system is further configured to facilitate execution of at least one vehicular control action associated with the command packet associated with each authorized command source based at least on the determined priority level of the each authorization source, wherein the at least one vehicular control action is executed by a vehicle equipped with the system. Further, the system is configured to generate a compliance log including a cryptographic record of the determined priority level, the at least one vehicular control action, the set of authentication parameters, vehicle response, and contextual telemetry. Furthermore, the system is configured to store the compliance log in a database associated with the system.

### BRIEF DESCRIPTION OF THE DRAWINGS

The following detailed description of illustrative embodiments is better understood when read in conjunction with the appended drawings. For the purpose of illustrating the present disclosure, exemplary constructions of the disclosure are shown in the drawings. However, the present disclosure is not limited to a specific device or a tool and instrumentalities disclosed herein. Moreover, those skilled in the art will understand that the drawings are not to scale. Wherever possible, like elements have been indicated by identical numbers:

FIG. 1 illustrates an example representation of an environment related to at least some example embodiments of the present disclosure;

FIG. 2 illustrates a simplified block diagram of a system for receiving and processing external control commands and modifying vehicular behavior accordingly, in accordance with an embodiment of the present disclosure; and

FIG. 3 illustrates a flow chart illustrating a method for determining command-based vehicular control, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification does not necessarily refer to the same embodiment, nor are separate or alternative embodiments mutually exclusive of other embodiments. Moreover, various features are described that may be exhibited by some embodiments and not by others. Similarly, various requirements are described that may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features may be provided independently of other features. Accordingly, this description of the present disclosure is set forth without any loss of generality to, and without imposing limitations upon, the present disclosure.

### OVERVIEW

In an embodiment, a computer-implemented method is disclosed. The computer-implemented method performed by a system includes receiving a command packet transmitted from at least one authorized command source via a communication channel. The method includes authenticating the command packet and a set of authentication parameters associated with the command packet based at least on validating an authentication identifier associated with the command packet using a public key infrastructure defined for the command packet. Upon successful authentication of the command packet and the set of authentication parameters, the method includes determining a priority level of the command packet received from each authorized command source of the at least one authorized command source based on a predefined hierarchy of issuing authorities. Further, the method includes facilitating execution of at least one vehicular control action associated with the command packet associated with each authorized command source based at least on the determined priority level of the each authorization source. The at least one vehicular control action is executed by a vehicle equipped with the system. The method further includes generating a compliance log including a cryptographic record of the determined priority level, the at least one vehicular control action, the set of authentication parameters, vehicle response, and contextual telemetry. Furthermore, the method includes storing the compliance log in a database associated with the system.

Further, authenticating the set of authentication parameters of each command packet includes verifying whether the command packet is received within a predefined time window based at least on a timestamp of the command packet. The method further includes verifying an authorization certificate associated with the at least one authorized command source based at least on an authorized registry stored in the database associated with the system. Furthermore, the method includes verifying the geographic relevance of the at least one authorized command source.

The method further includes assigning a priority value for the command packet received from each authorized command source of the at least one authorized command source based at least on the predefined hierarchy of issuing authorities. The method includes determining the priority level of the at least one authorized command source based at least on the priority value assigned to the command packet of each of the at least one authorized command source and a timestamp of the receipt of the at least one authorized command source.

Further, the at least one vehicular control action includes adjusting a speed parameter of the vehicle, initiating a lateral maneuver including a lane change, lane yield, or road shoulder pull-over, overriding a navigation system associated with the vehicle to initiate a rerouting path in accordance with regional restrictions or evacuation corridors, activating indicators associated with the vehicle to signal compliance status of the vehicle to other vehicles or pedestrians in proximity, transmitting a compliance acknowledgment to the other vehicles in proximity using a vehicle-to-vehicle (V2V) communication protocol or to the at least one authorized command source, and logging an executed vehicular control action of the at least one vehicular control action and associated telemetry as a compliance record.

Upon successful authentication, the method includes whether the command packet is classified as at least one of a low-priority category and a non-emergency category based on the priority level of the command packet received from at least one authorized command source. Further, the method includes facilitating contextual verification of the command packet based on at least on one or more contextual parameters. The method further includes configuring a delay in execution of the command packet for a predefined buffer period to validate the command packet based at least on the receipt of a confirmatory message from other vehicles in the proximity via vehicle-to-vehicle (V2V) communication protocol.

The method includes detecting a connectivity failure between an authorized command source of the at least one authorized command source during execution of a previously authenticated command packet of the authorized command source, and activating a fail-safe mode in response to detecting the connectivity failure. The method further includes creating a log of the connectivity failure in the database associated with the system during execution of the previously authenticated command packet of the authorized command source. The method includes broadcasting an emergency status associated with the vehicle to other vehicles in proximity via a vehicle-to-vehicle (V2V) communication protocol in response to activating the fail-safe mode. The method includes executing at least one fail-safe operation in the vehicle upon broadcasting the emergency status of the vehicle to the other vehicles in proximity. The at least one fail-safe operation is defined for the fail-safe mode.

The method further includes executing an emergency operation in the vehicle in response to detection of the connectivity failure, wherein the fail-safe mode is activated in the vehicle upon executing the emergency operation. The method further includes facilitating a re-verification of the previously authenticated command packet using a public key infrastructure within a predefined time interval. The method includes activating an override lockout mode in the vehicle to temporarily suspend subsequent command packet authentication upon failure to reverify the previously authenticated command packet within the predefined time interval.

The method includes determining whether the command packet received from the at least one authorized source is related to an emergency priority, determining whether the command packet related to the emergency priority applies to a current location and route context associated with the vehicle, generating a route confirmation message indicating successful interpretation of the command packet to the current location and the route context, and facilitating execution of the at least one vehicular control action associated with the command packet based at least on the route confirmation message.

The method further includes determining whether the vehicle is operating in a fleet mode with other vehicles in response to determining the command packet related to the emergency priority applies to the current location and the route context associated with the vehicle. The method includes transmitting the route confirmation message indicating successful interpretation of the command packet to the current location and the route context.

The method further includes storing the compliance log in at least one of a cloud infrastructure and a blockchain ledger communicably coupled to the system. The compliance log is hashed using a cryptographic key associated with the vehicle. The method includes providing access to the compliance log stored in at least one of the cloud infrastructure, the database associated with the system, and the blockchain ledger to the at least one authorized command source to perform verification of the compliance log. Further, the at least one authorized command source includes military command centers, federal or state law enforcement agencies, emergency response organizations, municipal police departments, and civilian or insurance-related entities.

The present disclosure provides several advantages such as the system ensures that all incoming commands are authenticated using the public key infrastructure (PKI), signature verification, and authority fingerprint validation. This multi-layer authentication significantly reduces the risk of spoofed or unauthorized commands being executed, especially in sensitive or high-security environments such as law enforcement and military operation. Further, by incorporating nonce-based freshness checks and hash-based packet integrity verification, the system may instantly detect any attempt to modify a command in transit. This feature enhances the trustworthiness of real-time communication in dynamic, vehicle-to-network (V2N) and vehicle-to-vehicle (V2V) environments. Furthermore, the system incorporates continuous real-time monitoring for irregular command activity, such as unusual command frequency, mismatched issuer credentials, or multi-source injections. This predictive anomaly detection allows proactive defense against cyber-physical attacks or insider threats. Despite employing robust encryption and verification mechanisms, the system is optimized for real-time applications through lightweight packet design and edge execution strategies. This balance ensures security is not achieved at the expense of delay in emergency or high-priority scenarios. In addition to cryptographic validation, the system verifies geofencing and jurisdictional relevance before acting on received commands. This prevents command spoofing across regions and ensures lawful command enforcement only by authorized entities. Also, all command interactions, executed or rejected, are logged in secure storage and, in some embodiments, hashed to a blockchain ledger. This facilitates regulatory compliance, forensic review, and non-repudiation in post-incident investigations.

Further, the system and method disclosed herein may be identified under the designation ScrollCommand™, which refers to a protocol-sealed override and cryptographic logging framework. In addition, terms such as Snap+Log™, Vault Terminal™, and SOVRAN™ are proprietary identifiers developed by D3 Dynasty Holdings Inc. The above-mentioned terms are utilized throughout the present application solely for descriptive and reference purposes, in order to distinguish and denote specific core modules within the overall system architecture. It should be noted that these designations do not presently represent registered trademarks. Their inclusion in this application is not intended to limit or otherwise affect the scope of the invention or the claims set forth herein.

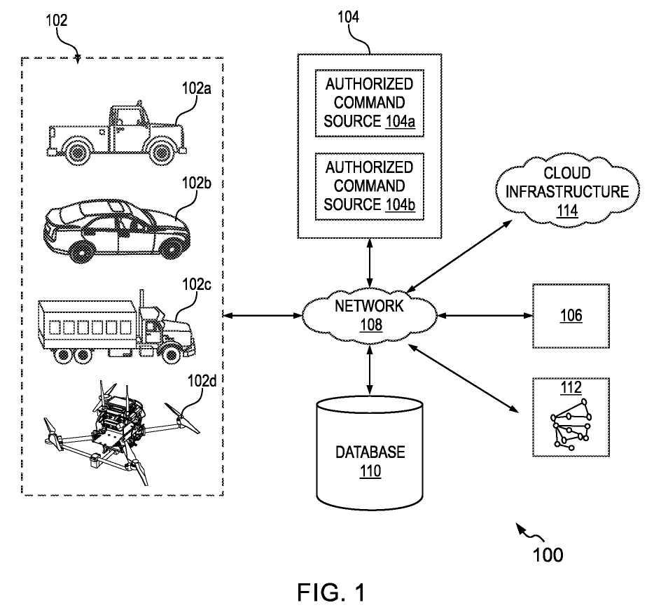

Various example embodiments of the present disclosure are described hereinafter with reference to FIGS. 1 - 3 .

FIG. 1 illustrates an example representation of an environment 100 related to at least some example embodiments of the present disclosure. Although the environment 100 is presented in one arrangement, other arrangements are also possible where the parts of the environment 100 (or other parts) are arranged or interconnected differently. The environment 100 generally includes a plurality of vehicles 102. The plurality of vehicles 102 includes a vehicle 102a, a vehicle 102b, a vehicle 102c, and a vehicle 102d (drone).

In an embodiment, the plurality of vehicles 102 may include autonomous civilian vehicles, including private passenger cars and autonomous sedans. In another embodiment, the plurality of vehicles 102 (hereinafter interchangeably referred to as “the vehicles 102”) may include emergency service vehicles, including autonomous or semi-autonomous ambulances, police vehicles, and fire department units. In another embodiment, the plurality of vehicles 102 may include civilian vehicles configured to integrate with military operations. Such vehicles respond to high-priority military-issued directives, such as enabling convoy movement or clearing strategic routes. These vehicles may automatically perform maneuvers such as pulling over or yielding to military units and are governed by a command hierarchy in which military authority supersedes civilian or law enforcement directives. This functionality supports coordinated national security operations involving mixed civilian-military traffic environments. In some embodiments, the plurality of vehicles 102 may include commercial freight and logistics vehicles, such as autonomous trucks and delivery vans. In an embodiment, the plurality of vehicles 102 may include drone-type aerial vehicles, which may either transmit commands to ground vehicles or receive directives themselves. Examples include surveillance drones operated by law enforcement, search-and-rescue unmanned aerial vehicles (UAVs), and delivery drones operating in urban environments.

Further, the environment 100 includes at least one authorized command source 104. The at least one authorized command source 104 may include an authorized command source 104aand an authorized command source 104b. The at least one authorized command source 104 refers to verified entities permitted to issue digitally signed command packets that trigger vehicular control actions. The at least one authorized command source 104 is authenticated using public key infrastructure (PKI) and ranked according to a predefined hierarchy of issuing authorities to ensure lawful and prioritized execution. Some non-limiting examples of the at least one authorized source 104 may include military authorities, federal and state law enforcement, local law enforcement, emergency response agencies, insurance companies, or regulatory bodies.

The environment 100 further includes a system 106 and a database 110 associated with the system 106. The system 106 may be embodied in at least one computing device in communication with a network 108. In an embodiment, the system 106 may be embodied in each of the plurality of vehicles 102 (or the vehicles 102a-102c). The system 106 may be specifically configured, via executable instructions, to perform one or more of the operations described herein. In general, the system 106 is configured to facilitate centralized command authentication, policy enforcement, and coordination of system-wide behavior across the vehicles 102 and the at least one command source 104, which will be explained further in detail.

Various entities in the environment 100 may connect to the network 108 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, or any combination thereof. In some instances, the network 108 may include a secure protocol (e.g., Hypertext Transfer Protocol (HTTP)), and/or any other protocol, or set of protocols. In an example embodiment, the network 108 may include, without limitation, a local area network (LAN), a wide area network (WAN) (e.g., the Internet), a mobile network, a virtual network, and/or another suitable public and/or private network capable of supporting communication among two or more of the entities illustrated in FIG. 1, or any combination thereof. In some embodiments, the network 108 may include Dedicated Short-Range Communications (DSRC), Cellular Vehicle-to-Everything (C-V2X), and satellite communications, such as Global Positioning System (GPS), Starlink, and the like.

In operation, the system 106 is configured to receive a command packet transmitted from the at least one authorized command source 104 via a communication channel (i.e., the network 108). As explained above, the system 106 may be equipped in each of the plurality of vehicles 102. In one example scenario, the command packet may be received by the system 106 that is equipped in the vehicle 102a. Upon receipt of the command packet, the system 106 authenticates the command packet and a set of authentication parameters associated with the command packet. In particular, the system 106 verifies the command packet received from the at least one authorized command source 104 based at least on validating an authentication identifier (such as a digital signature or an authentication certificate) associated with the command packet using a public key infrastructure (PKI) defined for the command packet. Upon successful authentication, the system 106 determines a priority level of the command packet received from each authorized source of the at least one authorized source 104, based on a predefined hierarchy of issuing authorities. For example, the system 106 may receive the command packet from the authorized command source 104a, followed by the authorized command source 104c and the authorized command source 104b. Further, the predefined hierarchy of issuing authorities may be defined based on the timestamp of the receipt of the command packet. In this example scenario, the system 106 determines the priority level as the authorized command source 104a, the authorized command source 104c, and the authorized command source 104b in the ascending order. Further, the system 106 facilitates execution of at least one vehicular control action associated with the command packet associated with each authorized command source (such as the at least one authorized command source 104) based at least on the determined priority level. The at least one vehicular control action is executed by a vehicle (e.g., the vehicle 102a) equipped with the system 106. Thereafter, the system 106 generates a compliance log including a cryptographic record of the determined priority level, the at least one vehicular control action, the set of authentication parameters, vehicle response, and contextual telemetry. Further, the system 106 stores the compliance log in the database 110 associated with the system 106. In one embodiment, the environment 100 includes a blockchain ledger (see, 112) and a cloud infrastructure (see, 114) for storing the compliance log. The blockchain ledger 112 and the cloud infrastructure 114 are communicably coupled to entities of FIG. 1 via the network 108.

In an embodiment, to facilitate low-latency communication for time-sensitive operations, the system 106 utilizes real-time transport protocols, such as user datagram protocol (UDP) multicast, for the dissemination of critical control commands. These protocols are particularly applied in scenarios involving public safety, disaster response, or tactical zones (e.g., active shooter situations).

The number and arrangement of systems, devices, and/or networks shown in FIG. 1 are provided as an example. There may be other systems, devices, and/or networks; fewer systems, devices, and/or networks; different systems, devices, and/or networks, and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices.

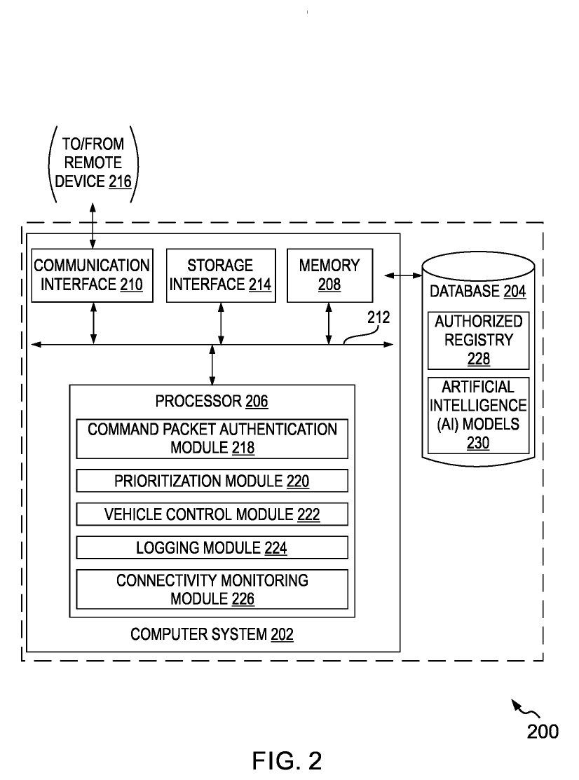

FIG. 2 illustrates a simplified block diagram of a system 200 for receiving and processing external control commands and modifying vehicular behavior accordingly, in accordance with an embodiment of the present disclosure. Examples of the system 200 may include, but are not limited to, the system 106 as shown in FIG. 1. The system 200 includes a computer system 202 and a database 204. The computer system 202 includes at least one processor 206 for executing instructions, a memory 208, a communication interface 210, and a storage interface 214. The one or more components of the computer system 202 communicate with each other via a bus 212.

In one embodiment, the database 204 is integrated within the computer system 202 and is configured to store the compliance log including the cryptographic record of the determined priority level, the at least one vehicular control action, the set of authentication parameters, vehicle response, and contextual telemetry. The computer system 202 may include one or more hard disk drives as the database 204. The storage interface 214 is any component capable of providing the processor 206 access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204.

The processor 206 includes suitable logic, circuitry, and/or interfaces to execute computer-readable instructions. Examples of the processor 206 include, but are not limited to, an application-specific integrated circuit (ASIC) processor, a reduced instruction set computing (RISC) processor, a complex instruction set computing (CISC) processor, a field-programmable gate array (FPGA), and the like. The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the system 200, as described herein. In some embodiments, the memory 208 may be realized in the form of a database or cloud storage working in conjunction with the system 200, without deviating from the scope of the present disclosure.

The processor 206 is operatively coupled to the communication interface 210 such that the processor 206 is capable of communicating with a remote device 216, such as the at least one authorized command source 104 and the plurality of vehicles 102, or with any entity connected to the network 108 as shown in FIG. 1.

It is noted that the system 200 as illustrated and hereinafter described is merely illustrative of an apparatus that could benefit from embodiments of the present disclosure and, therefore, should not be taken to limit the scope of the present disclosure. It is noted that the system 200 may include fewer or more components than those depicted in FIG. 2.

In one embodiment, the processor 206 includes a command packet authentication module 218, a prioritization module 220, a vehicle control module 222, a logging module 224, and a connectivity monitoring module 226. The processor 206 may include other engines/modules apart from those depicted in FIG. 2, therefore, it should not be taken to limit the scope of the present disclosure.

The command packet authentication module 218 includes suitable logic and/or circuitry for performing authentication of the command packet and the set of authentication parameters associated with the received command packet. As explained above, the command packet transmitted from the at least one authorized command source 104 is received at the system 200 via the communication channel (or the network 108). In particular, the command packet authentication module 218 is configured to perform cryptographic verification and contextual validation of the incoming command packet received from the at least one authorized command source 104. The command packet authentication module 218 ensures that only legitimate, timely, and jurisdictionally valid commands are acted upon by the vehicle (e.g., the vehicle 102a). Further, the command packet authentication module 218 performs a multi-stage authentication operation to authenticate the incoming command packet from the at least one authorized command source 104.

Specifically, the command packet authentication module 218 validates the authentication identifier, such as the digital signature embedded within the command packet, using the public key infrastructure of the command packet. That is, the command packet is digitally signed using a private key by an authorized command source (such as the authorized command source 104a). Further, the corresponding public key (used for verification) may be stored in the database 204 of the system 200. The public key may be defined by reference to the command packet’s origin or the issuing authority (e.g., military, police, emergency agency). This confirms that the public key used for verifying the command packet is defined and known to the system 200 based on the issuing authority. This ensures the integrity and authenticity of the command packet. In the event that the command packet authentication module 218 determines that the received command packet fails authentication, the system 200 may perform command rejection. That is, the command packet is immediately rejected, and no vehicular control action associated with the unauthenticated packet is executed. This ensures that unauthorized, spoofed, or tampered commands have no operational effect on the vehicle's behavior. Additionally, the processor 206 may log the rejected command and/or reasons (such as spoofing or anomaly detection) associated with the command rejection.

Additionally, the command packet authentication module 218 is configured to authenticate the set of authentication parameters of each command packet. For example, the set of authentication parameters may include a predefined time window, an authorization certificate, and geographic relevance.

The command packet authentication module 218 is configured to verify whether the command packet is received within the predefined time window based at least on a timestamp of the command packet. The command packet includes the timestamp indicating the time at which the command packet is generated and digitally signed by the authorized command source (e.g., the authorized command source 104a). Upon receipt, the command packet authentication module 218 compares the timestamp against the vehicle’s (such as the vehicle 102a) own synchronized system time, which may be obtained from an onboard clock or an external time source such as GPS-based. If the difference between the current time and the received timestamp exceeds the predefined time window (e.g., ±5 seconds, ±30 seconds, or ±2 minutes, depending on policy or priority level), the command packet may be considered invalid due to timestamp expiration, and such a command packet may be rejected without execution.

The command packet authentication module 218 is configured to verify an authorization certificate associated with the at least one authorized command source 104 based at least on an authorized registry 228 stored in the database 204 associated with the system 200. The authorized registry 228 may include a plurality of certificate entries, each corresponding to a known, verified command source (e.g., police department, military unit, emergency services agency). The command packet authentication module 218 verifies the authorization certificate associated with the command packet based on matching the authorization certificate with a valid entry in the authorized registry 228. The matching of the authorization certificate with the valid entry in the authorized registry 228 ensures the authorization certificate is not spoofed. For example, the authorization certificate may be assigned a certificate identifier (ID) “CPDLA-01”. In this example scenario, the command packet authentication module 218 queries the authorized registry 228 for “CPDLA-01” and verifies if a matching entry for the certificate ID “CPDLA-01” is available in the authorized registry 228 that is marked as active. If a matching entry is found, the command packet is successfully verified.

Further, the command packet authentication module 218 is configured to verify the geographic relevance of the at least one authorized command source 104. Specifically, the command packet authentication module 218 is configured to evaluate the geographic relevance of the command packet to confirm whether the issuing authority (e.g., the authorized command source 104a) is in legitimate jurisdiction over the vehicle’s (e.g., the vehicle 102a) current operational location. The processor 206 may determine the current coordinates of the vehicle 102a using a Global Navigation Satellite System (GNSS) module. For example, the current GPS-based location may include latitude: 34.0522° N, longitude: 118.2437° W – representing Los Angeles, CA. Further, the received command packet may include a geofence tag or jurisdictional boundary definition (e.g., city-level geofence, county, district, a designated road segment, or corridor). The command packet authentication module 218 further compares the vehicle's (e.g., the vehicle 102a) current coordinates (34.0522, -118.2437) against the geofence tag defined in the command packet to confirm whether the vehicle 102a is within the geofence region of the authority's jurisdiction as encoded in the command packet. If the vehicle's (e.g., the vehicle 102a) current location is within the defined geofence region, the command packet authentication module 218 confirms jurisdictional applicability of the command packet. Further, if the vehicle 102ais located outside the defined geofence region, the command packet is either rejected as invalid or deferred until the vehicle 102a enters the geofence region. Upon verifying that the command packet is authentic and jurisdictionally applicable, the processor 206 determines the priority level of the command packet.

The prioritization module 220 determines a priority level of the command packet received from each authorized command source of the at least one authorized command source 104 based on a predefined hierarchy of issuing authorities. In one embodiment, the predefined hierarchy includes a plurality of ranked authority classes, each associated with a respective priority value. The issuing authorities (also referred to as the at least one authorized command source 104) may include, for example, military command centers, federal or state law enforcement agencies, emergency response organizations, municipal police departments, and civilian or insurance-related entities. Each authority class is assigned a relative position in the predefined hierarchy, such that command packets originating from higher-ranked authorities are assigned a higher execution priority than those from lower-ranked authorities. For example, the predefined hierarchy of the issuing authorities, ranked from highest to lowest priority, is as follows military command centers, federal or state law enforcement agencies, emergency response organizations, municipal police departments, and civilian or insurance-related entities.

Specifically, the prioritization module 220 may apply a weighted priority system to assign a priority value to the command packet of each of the at least one authorized command source 104. The priority value is assigned based at least on the predefined hierarchy of issuing authorities. Additionally, the priority level is determined based at least on the timestamp associated with the receipt of the command packet from the respective authorized command source 104. As a result, the prioritization module 220 determines the priority level of the at least one authorized command source 104 based at least on the priority value assigned to the command packet of each of the at least one authorized command source 104 and the timestamp of the receipt of the at least one authorized command source 104. The priority level reflects the operational precedence of the command and governs the sequencing and resolution of overlapping or concurrent commands.

In one example, a state police agency and a local emergency service simultaneously issue command packets such as command packet A and command packet B, respectively. and to the same vehicle (such as the vehicle 102a). Further, the timestamp of the receipt of the command packets A and B by the vehicle 102a may be 8:42:10 AM UTC, and 8:42:08 AM UTC, respectively. The prioritization module 220 assigns the priority value of “2” and “3” to the command packets A and B, respectively. It is to be noted that, in the predefined hierarchy of issuing authorities, a lower numerical priority value corresponds to a higher priority level. Thus, in this example, the command packet A has a higher authority (lower numerical priority value) than the command packet B, even though the command packet B is received 2 seconds later than the command packet A. Thus, the prioritization module 220 prioritizes the command packet A over the command packet B and enables the processor 206 to execute the command packet A based on the determined priority level. Further, the command packet B may be suppressed or queued for deferred execution.

The vehicle control module 222 includes suitable logic and/or interfaces to facilitate execution of at least one vehicular control action associated with the command packet associated with each authorized command source based at least on the determined priority level of the each authorization source. The at least one vehicular control action is executed by a vehicle (e.g., the vehicle 102a) equipped with the system 200. The at least one vehicular control action may include, but not limited to, adjusting a speed parameter of the vehicle (e.g., the vehicle 102a), initiating a lateral maneuver (such as a lane change, lane yield, or road shoulder pull-over), overriding a navigation system associated with the vehicle 102a to initiate a rerouting path in accordance with regional restrictions or evacuation corridors, activating indicators associated with the vehicle 102a to signal compliance status of the vehicle 102a to other vehicles (e.g., the vehicles 102b-102c) or pedestrians in proximity,transmitting a compliance acknowledgment to the other vehicles 102b-102c in proximity using a vehicle-to-vehicle (V2V) communication protocol or to the at least one authorized command source 104, and logging an executed vehicular control action of the at least one vehicular control action and associated telemetry as a compliance record.

In an embodiment, the vehicle control module 222 facilitates execution of the at least one vehicular control action only for the command packet associated with the highest priority level when multiple command packets are concurrently valid. In another embodiment, the vehicle control module 222 facilitates the execution of the at least one vehicular control action of multiple command packets upon determining that the concurrent execution is deemed safe and non-conflicting, andthe priority level of the multiple command packets.

The vehicle control module 222 is operatively coupled to one or more artificial intelligence (AI) models 230, that is configured to a plurality of domain-specific subroutines, each corresponding to a distinct category of the at least one authorized command source 104. Each subroutine is trained using supervised learning techniques on labeled datasets that represent real-world or simulated scenarios. For instance, for military override subroutine, the AI models 230 may be trained on convoy coordination datasets, checkpoint clearance events, and urgent route deconfliction maneuvers. For law enforcement, the AI models 230 may be trained using traffic stop videos, dashcam footage, and route compliance data. In an embodiment, in controlled environments or simulations, the AI models 230 may be trained using reinforcement learning to fine-tune the response logic by rewarding successful, compliant actions and penalizing unsafe or non-conforming ones. This is used for route negotiation, yielding behavior, or convoy interactions. In some embodiments, to ensure adaptability across jurisdictions or fleet types, the AI models 230 may be trained with domain adaptation using region-specific data (e.g., differing traffic laws, emergency signal protocols, or insurance norms). In fleet-scale deployments, the AI models 230 may be trained using a federated learning technique.

Upon successful authentication of the command packet (including the validation of the digital signature, the timestamp, the authorization certificate, and the geographic relevance), the vehicle control module 222 determines an issuer category (e.g., military command centers, federal or state law enforcement agencies, emergency response organizations, municipal police departments, and civilian or insurance-related entities). The vehicle control module 222 then invokes the corresponding behavioral subroutine mapped to the identified issuer category. For example, upon successful authentication, the vehicle control module 222 identifies the issuer category as “Law Enforcement” and selects the corresponding subroutine. The selected law enforcement subroutine may include an AI model pre-trained on compliance scenarios including safe deceleration, lane selection for shoulder pullovers, and activation of visual compliance indicators. Based on the vehicle’s (e.g., the vehicle 102a) current state and environmental context, the AI models 220 generate a control signal sequence that is passed to the vehicle control module 222, including a gradual deceleration profile, a steering maneuver to direct the vehicle 102a to the nearest safe shoulder or roadside area, and activation of hazard lights and compliance flashers to indicate awareness of law enforcement instruction. Throughout the maneuver, telemetry data including position, velocity, control decisions, and video sensor snapshots is logged. Additionally, the vehicle control module 222 may further restrict re-entry into traffic until a secondary command packet is received from the same or higher-authority issuer indicating clearance to resume autonomous operation, or until a manual override is triggered by an authorized human operator.

In one example, the selected subroutine may be a military override subroutine. In this example scenario, the vehicle control module 222 in conjunction with the AI models 230, outputs the response that direct the vehicle 102a to decelerate, vacate its current lane, and pull onto the shoulder. Simultaneously, the vehicle 102a may broadcast a mesh network compliance signal to nearby vehicles (or the other vehicles 102b-102c).

In another example, the selected subroutine may be an emergency/fire subroutine. In this example scenario, the vehicle control module 222 in conjunction with the AI models 230, outputs the response related to lateral repositioning to create a dynamic lane gap, reduced acceleration, and activation of visual indicators (e.g., turn signals or voice alerts) to inform nearby drivers or passengers of the emergency response.

In another example, the selected subroutine may be an insurance compliance subroutine. In this example scenario, the vehicle control module 222 in conjunction with the AI models 230, activates internal forensic logging routines without triggering any physical vehicle maneuver. The vehicle control module 222 records vehicle state data, control decisions, and sensor streams into a secure, cryptographically sealed log. Further, this data is subsequently transmitted to the insurer for liability assessment.

In some embodiments, the prioritization module 220 determines whether the command packet is classified as at least one of a low-priority category and a non-emergency category based on the priority level of the command packet received from at least one authorized command source 104. For example, the command packet assigned a priority level of 1 or 2 (e.g., issued by the military command centers or the federal or state law enforcement agencies) may be classified as high-priority and emergency-related. Further, the command packet assigned a priority level of 4 or 5 (e.g., issued by themunicipal police departments, and the civilian or insurance-related entities) may be classified as the low-priority category and the non-emergency category. Upon classification as the low-priority or the non-emergency categories, the processor 206 is configured to perform contextual verification of the command packet based on at least on one or more contextual parameters. The contextual verification is performed to assess the operational relevance and situational appropriateness of executing the command packet. The one or more contextual parameters may include, but are not limited to, current speed, trajectory, and route of the vehicle (e.g., the vehicle 102a), the presence, distance, and movement patterns of the other vehicles 102b-102cin proximity to the vehicle 102a, environmental and road condition data (e.g., traffic congestion, road closures), current geographic location relative to the target zone indicated in the command packet, and system health diagnostics (e.g., signal strength, fallback mode status, etc.) or sensor-derived observations.

To prevent premature or unnecessary control actions in response to the low-priority category command packet, the processor 206 configures a delay in execution of the command packet for a predefined buffer period. The processor 206 configures the delay in execution of the command packet for the predefined buffer period tovalidate the command packet based at least on the receipt of a confirmatory message from other vehicles (e.g., the vehicles 102b-102c) in the proximity via vehicle-to-vehicle (V2V) communication protocol. The vehicle-to-vehicle (V2V) communication protocol refers to a wireless communication system that allows the vehicles (such as the vehicles 102a-102c) to exchange information with each other directly, without relying on centralized infrastructure such as cellular networks or roadside units.In one scenario, the confirmatory message may indicate thatother vehicles (e.g., the vehicles 102b-102c) nearby have received the same or a similar command packet. In another scenario, the confirmatory message may indicate that the command packet is regionally or situationally consistent with observed traffic behavior. In another scenario, the confirmatory message may indicate that the authorized command source (e.g., the authorized command source 104a) is broadcasting an area-wide low-priority instruction validated by fleet consensus. If the confirmatory message is received within the predefined buffer period, the processor 206 proceeds with execution of the low-priority category command packet and the at least one vehicular control action associated with the low-priority category command packet. In case of non-receipt of the confirmatory message, the processor 206 may defer, reclassify, or discard the command packet.

The logging module 224 includes suitable logic and/or circuitry to generate a compliance log. The compliance log may include, but not limited to, the cryptographic record of the determined priority level, the at least one vehicular control action, the set of authentication parameters, vehicle response, and contextual telemetry. Further, the logging module 224 storesthe compliance log in the database 204 associated with the system 200. In an embodiment, the logging module 224 logs the executed vehicular control action of the at least one vehicular control action and associated telemetry as the compliance record in the database 204. For example, the database 204 may be a trusted platform module (TPM) or a secure enclave chip embedded within the vehicle (e.g., the vehicle 102a). This provides immediate tamper resistance at the edge, ensuring that authentication data, executed control actions, and contextual telemetry are captured in a cryptographically protected environment. Further, storing the compliance log in the database 204 provides real-time storage while maintaining the physical integrity of the data in the absence of network connectivity.

In some embodiments, the logging module 224 is further configured to log the rejected or ignored command packets for purposes of post-event forensic analysis. This logging process captures the metadata associated with each unexecuted command packet, including but not limited to the issuer identity and the authorization certificate details, the reason for rejection (e.g., authentication failure, failed contextual verification, low priority without confirmation), the timestamp and geographic location of the receipt of the command packet, and the current operational state of the vehicle (e.g., the vehicle 102a) at the time of command packet receipt. The logs are stored in a secure memory area (e.g., the database 204). In some implementations, the logs may be hashed and written to the blockchain ledger (see, 112) to ensure immutability and verifiability during later audits or investigations. This provides tamper-evident integrity, auditability, and long-term legal admissibility, particularly in multi-jurisdictional or evidentiary use cases.

In further embodiments, the processor 206 may interface with a machine learning-based feedback loop configured to refine command trust scoring models over time. When deployed, the processor 206 may analyze historical data related to the issuer authority, including execution outcomes, compliance behavior, and the frequency and context of false-positive or conflicting command packets.Based on the analysis, the processor 206 may dynamically adjust internal scoring metrics or classification thresholds. In one scenario, the command packet from historically reliable issuing authorities may be verified and executed more quickly or with reduced contextual delay. In another scenario, the command packet from less consistent or infrequently seen sources may be subjected to heightened scrutiny, extended delay buffers, or cross-vehicle confirmation requirements. This adaptive refinement process enables the processor 206 to evolve in response to operational conditions and threat models, enhancing its ability to distinguish between trusted and potentially adversarial command activity.Collectively, these measures ensure that the processor 206 maintains a high standard of operational integrity and trustworthiness, even in unpredictable, high-threat, or multi-agency deployment environments. Additionally, the system 200 is designed to guard against misuse, whether intentional or inadvertent, while preserving real-time responsiveness to the legitimate issuing authority.

In one embodiment, the logging module 224 is configured to store the compliance log in thecloud infrastructure (see, 114). In this scenario, the logging module 224 may further synchronize encrypted copies of the compliance log with a backend server (not shown in FIGS.) operated by the issuing authority (or the at least one authorized command source 104). This enables centralized monitoring, remote audit retrieval, and fleet-wide compliance aggregation.

In some embodiments, the system 200 is configured to implement a secure transmission and end-to-end verification protocol for transmitting the compliance log to external systems such as the cloud infrastructure 114 or the blockchain ledger 112. This multi-layered protocol ensures both confidentiality during transmission and immutability of the stored compliance log, supporting evidentiary-grade auditability in regulatory, legal, and high-risk operational contexts. For example, to secure the transmission path, all outgoing data, including the compliance log, the command execution results, and telemetry data, are encrypted using Transport Layer Security (TLS) version 1.3 or an equivalent cryptographic protocol that supports mutual authentication between the vehicle (e.g., the vehicle 102a) and the receiving system (e.g., the other vehicles 102b-102c, the cloud infrastructure 114, or the blockchain ledger 112). Further, to ensure verifiable integrity, each compliance log sent to the cloud infrastructure 114 or the blockchain ledger 112 is digitally signed using the vehicle’s cryptographic identity keypair, which is securely stored in the database 204. Furthermore, each log entry in the compliance log may be hashed, time-locked, and cryptographically chained to prior entries, forming a tamper-evident sequence of records suitable for audit purposes.

In one embodiment, the system 200 provides access to the compliance log stored in at least one of the cloud infrastructure 114, the database 204 associated with the system 200, and the blockchain ledger 112 to the at least one authorized command source 104 to perform verification of the compliance log. For example, the authorized command source 104a(e.g., the insurance-related entities) is a verifier who retrieves the compliance log related to the vehicle 102a from the cloud infrastructure 114. Thereafter, the authorized command source 104arecomputes the hash using the raw log data and compares the recomputed hash to the original hash of the compliance log. If the hash values match, the compliance log is confirmed to be authentic, untampered, and time-consistent.

The connectivity monitoring module 226 includes suitable logic and/or circuitry configured to detect a connectivity failure between an authorized command source (e.g., the authorized command source 104a) of the at least one authorized command source 104 during execution of a previously authenticated command packet of the authorized command source 104a. As a result, the connectivity monitoring module 226 activates a fail-safe mode in response to detecting the connectivity failure. In particular, while executing the authenticated command packet, the connectivity monitoring module 226 continuously monitors the communication channel between the vehicle (e.g., the vehicle 102a) and the authorized command source 104a. If a disruption in connectivity is detected, such as a loss of signal, communication timeout, or route-level disconnection, the processor 206 autonomously initiates the fail-safe mode without requiring manual override or external triggers. For example, the fail-safe mode is configured to activate pre-loaded fallback behavioral routines within a latency window of less than 200 milliseconds. The fallback routines maintain vehicle or system safety during communication delays or signal degradation events.

Further, the logging module 224 creates a log of the connectivity failure in the database 204 associated with the system 200 during execution of the previously authenticated command packet of the authorized command source 104a. The log may include vehicle telemetry, control state, and failure metadata. Simultaneously, the processor 206 broadcasts an emergency status of the vehicle 102a to the other vehicles (e.g., the vehicles 102b-102c) in proximity via the vehicle-to-vehicle (V2V) communication protocol in response to activating the fail-safe mode. This broadcast informs the other vehicles 102b-102cin proximity that the affected vehicle (e.g., the vehicle 102a) is operating in the fail-safe mode, facilitating coordinated behavior among surrounding autonomous or semi-autonomous systems.

Upon broadcasting the emergency status to the other vehicles 102b-102c in proximity, the vehicle control module 222 executes at least one fail-safe operation in the vehicle 102a. The at least one fail-safe operation is defined for the fail-safe mode associated with the vehicle 102a. The at least one fail-safe operation executed may be selected from a set of fail-safe operations stored in the database 204. The set of fail-safe operationsmay be context-aware and defined based on vehicle class, operational zone, or mission context. In one example, a civilian vehicle under a law enforcement stop command will remain stationary with hazard lights activated until timeout or command re-verification. In another example, a military convoy vehicle may hold its position for a defined interval (e.g., 30 to 90 seconds) while waiting for a convoy ping, thereafter rerouting if no update is received. In another example, an insurance-only vehicle may log the status (e.g., the connectivity failure) without altering its driving path.

Further, the processor 206 enables the command packet authentication module 218 to perform a re-verification of the previously authenticated command packet using the public key infrastructure within a predefined time interval. The re-verification of the previously authenticated command packet is conducted within the predefined time interval to allow restoration of control of the vehicle 102aunder secure and authorized conditions. If re-verification is successful, the processor 206 resumes normal execution of the directive. However, if re-verification fails or the predefined time interval lapses, the processor 206 activates an override lockout mode. The override lockout mode temporarily suspends subsequent command packet authentication attempts in the vehicle 102a. Further, the override lockout mode ensures that no unauthorized or spoofed command packets are processed during degraded communication conditions. Furthermore, the processor 206 may maintain the override lockout mode until a trusted connectivity channel is re-established and re-authentication of a valid command packet is successful. During this period, the vehicle 102aremains in a restricted control state, either maintaining its current safe position or operating under constrained autonomy with elevated safety rules. Further, all fail-safe transitions, re-verification results, and override lockout entries are securely recorded and retained in the database 204. The records may be accessed for legal, insurance, and command-chain auditing purposes, thereby supporting transparent accountability and mission-aligned behavior in autonomous vehicle deployments.

Additionally, the vehicle control module 222 (or the processor 206) executes an emergency operation in the vehicle 102a in response to detection of the connectivity failure. Upon executing the emergency operation, the fail-safe mode is activated in the vehicle 102a. In other words, upon activation of the fail-safe mode, the vehicle control module 222 completes any in-progress dynamic behavior (e.g., lane change, yield maneuver) to prevent unsafe interruption. Herein, the in-progress dynamic behavior corresponds to the emergency operation. Further, the vehicle 102atransitions to a predefined passive behavior, such as decelerating and pulling over to the nearest safe location while activating the visual hazard indicators of the vehicle 102a or any other visual indicators of the vehicle 102a.

In an embodiment, the prioritization module 220 determines whether the command packet received from the at least one authorized source (e.g., the authorized command source 104a) is related to an emergency priority.For example, the authorized command source 104a(e.g., state emergency agency) may initiate a mass disaster broadcast command packet with the emergency priority. Upon determining the command packet is related to the emergency priority, the processor 206 determines whether the command packet related to the emergency priority applies to a current location and route context associated with the vehicle (e.g., the vehicle 102a). In other words, the processor 206 compares the geofenced region or route segment specified in the command packet with the GPS location and intended path of the vehicle 102a, taking into account environmental awareness and real-time traffic conditions. If the command packet is applicable to the current location and the route context of the vehicle 102a, the processor 206 generates a route confirmation messagefor the vehicle 102a as it pertains to the vehicle’s 102acurrent location and the route context. The route confirmation message may include a status code, timestamp, and command reference ID, and is optionally logged or transmitted for compliance tracking. Thereafter, the vehicle control module 222 facilitates execution of the at least one vehicular control action associated with the emergency priority command packet. For example, the at least one vehicular action may include rerouting away from closed roads, shifting to evacuation corridors, or initiating compliance maneuvers such as stopping, yielding, or reducing speed, depending on the command type.

In one embodiment, the processor 206 (or the connectivity monitoring module 226) may determine whether the vehicle 102ais operating in a fleet mode with the other vehicles 102b-102c. The fleet mode may be determined based on vehicle role data, convoy configuration flags, or cooperative broadcast detection. The processor 206 may determine if the vehicle 102ais operating in the fleet mode in response to determining the command packet related to the emergency priority applies to the current location and the route context associated with the vehicle 102a. In this example scenario, the processor 206 transmits the route confirmation message indicating successful interpretation of the command packet to the current location and the route context. The V2V communication protocol enables the other vehicles 102b-102c in proximity to receive confirmation that the command packet has been interpreted successfully and applies to their shared route segment. This supports synchronized and consistent emergency behavior across all the vehicles (such as the vehicles 102a-102c) in the convoy or operational fleet. Further, upon completing the required vehicular control action, such as a reroute, detour, or stop condition, the processor 206 transitions the vehicle 102a back to normal autonomous operation. The route confirmation message and execution outcome may be retained in the database 204 for future command correlation and system-level analytics. Thus, it is understood that the system 200 is configured to autonomously and securely interpret emergency directives, determine operational applicability, coordinate with the other vehicles 102b-102c in proximity in the fleet mode, and execute compliant control actions in real-time. Further, the system 200 is beneficial during mass emergency events, disaster evacuation protocols, and mission-critical fleet deployments requiring minimal human intervention.

In an embodiment, the system 200 is configured to support command interoperability between aerial drones and ground-based vehicles to ensure coordinated behavior in shared operational zones. The system 200 facilitates secure, real-time communication and maneuver execution in response to airspace coordination directives, including landing clearance, path yielding, or positional hold. In one example, the authorized command source 104amay be an authorized drone, such as one operated by law enforcement, military, or emergency services. In this example scenario, the authorized drone may transmit a digitally signed command packet to one or more receiving vehicles (e.g., the vehicles 102a-102c) or aerial units (e.g., the vehicle 102d. The command packet may be broadcast over short-range or mid-range communication channels to designated receivers within a defined command radius via the communication channel (or the network 108). The receiving vehicle, such as the vehicles 102a-102c or the vehicle 102d, authenticates the incoming command packet using the public key infrastructure (PKI) as explained above. Upon successful authentication, the system 200 may parse the command packet to extract metadata, which may include the command type (e.g., YIELD_AIRSPACE, RELOCATE, HOLD_POSITION), zone coordinates, and time-to-live (TTL) values. The metadata may be used to determine both the nature of the directive and its spatial-temporal applicability to the recipient vehicle (e.g., the vehicles 102a-102c or the vehicle 102d). Further, the system 200 may determine whether the command zone overlaps with the current or projected trajectory of the recipient vehicle (e.g., the vehicles 102a-102c) or the aerial units (e.g., the vehicle 102d). Specifically, the system 200 may determine whether the command zone overlaps with the current or projected trajectory of the recipient vehicle (e.g., the vehicles 102a-102c) or the aerial units (e.g., the vehicle 102d) by calculating the intended route, altitude, or path band, and estimated time of arrival in the defined command zone. If the command is determined to be applicable based on location, timing, and current state, the system 200 proceeds to execute the corresponding vehicular control action. For example, a ground vehicle (such as the vehicles 102a-102c) may decelerate or pull to the side of the roadway to yield to an incoming drone landing, andaerial units (such as the vehicle 102d) may reroute or pause mid-flight to avoid airspace conflict.

In coordinated scenarios such as swarm operations or fleet convoys, the command packet may be relayed across units using vehicle-to-vehicle (V2V) or drone-to-drone (D2D) communication. This facilitates synchronized compliance behavior, especially in dense or contested mission environments. For example, a coordinated response mission involves a mixed fleet of ground vehicles (such as the vehicles 102a-102c) and aerial drones (such as the vehicle 102d) deployed for emergency logistics in a disaster-affected urban area. In this example scenario, the aerial drones (such as the vehicle 102d) may be configured to transport critical supplies, while the ground vehicles (such as the vehicles 102a-102c) may be configured to manage corridor access and route clearance. During operation, an emergency airspace deconfliction command is issued by a law enforcement drone (such as the authorized command source 104a). The command packet, digitally signed and authenticated via the PKI, instructs all the vehicles (such as the vehicles 102a-102d) in a specified zone to executethe command packet with instruction “YIELD_AIRSPACE”for a designated landing corridor. Upon receiving and authenticating the command, the lead ground vehicle (such as the vehicle 102a) part of a convoy verifies that the command packet applies to its current route segment. To that effect, the system 200 equipped in the vehicle 102a initiates a safe pullover maneuver and broadcasts the route confirmation message to the other vehicles (such as the vehicles 102b-102c) in the convoy using the V2V communication protocol. Simultaneously, nearby drones (such as the vehicle 102d) operating in swarm mode also receive the command packet via the D2D communication protocol and execute the instruction associated with the command packet. Hence, the V2V and D2D communication protocol sensure that all the vehicles 102a-102d in the swarm or convoy respond in a coordinated and time-consistent manner. This results in reducing command latency, avoids redundant conflicts, and maintaining a consistent safety envelope across the multi-vehicle system.

The present disclosure is formally assigned to D3 Dynasty Holdings Inc., governed under the T-97 Legacy Instrument, which serves as the holding instrument for all associated intellectual property and derivative works, including commercial modules licensed under REEDS™ (Resilient Enterprise Execution & Documentation System).

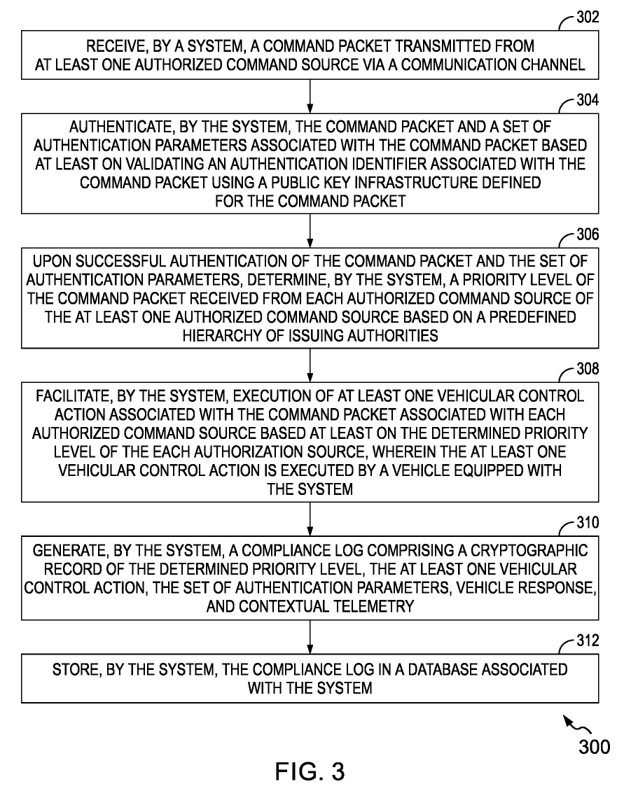

FIG. 3 illustrates a flow chart illustrating a method 300 for receiving and processing external control commands and modifying vehicular behavior accordingly, in accordance with an embodiment of the present disclosure. The method 300 depicted in the flow diagram may be executed by, for example, the system, such as the system 106 or the system 200. Operations of the method 300, and combinations of the operations in the method 300, may be implemented by, for example, hardware, firmware, a processor, circuitry, and/or a different device associated with the execution of software that includes one or more computer program instructions. The sequence of operations of the method 300 may not be necessarily executed in the same order as they are presented. Further, one or more operations may be grouped and performed in the form of a single step, or one operation may have several sub-steps that may be performed in parallel or a sequential manner. The method 300 starts with step 302.

At step 302, the method 300 includes receiving, by the system 200, the command packet transmitted from the at least one authorized command source 104 via a communication channel.

At step 304, the method 300 includes authenticating, by the system 200, the command packet and the set of authentication parameters associated with the command packet based at least on validating an authentication identifier associated with the command packet using a public key infrastructure defined for the command packet.

At step 306, upon successful authentication of the command packet and the set of authentication parameters, the method 300 includes determining, by the system 200, the priority level of the command packet received from each authorized command source of the at least one authorized command source 104 based on the predefined hierarchy of issuing authorities.

At step 308, the method includes facilitating, by the system 200, execution of at least one vehicular control action associated with the command packet associated with each authorized command source based at least on the determined priority level of the each authorization source. The at least one vehicular control action is executed by the vehicle equipped with the system 106.

At step 310, the method 300 includes generating, by the system 200, the compliance log including the cryptographic record of the determined priority level, the at least one vehicular control action, the set of authentication parameters, vehicle response, and contextual telemetry.

At step 312, the method 300 includes storing, by the system 200, the compliance log in the database 204 associated with the system 106. Further, one or more operations performed by the system 106/200 related to receiving and processing external control commands and modifying vehicular behavior accordingly are explained with reference to FIGS. 1 and 2, therefore, they are not reiterated for the sake of brevity.

The system (such as the system 200) and the method (such as the method 300) described herein are commercially referred to as ClearRoute.AI™, with proprietary modules known as ScrollCommand™, Snap+Log™, Vault Terminal™, REEDS™, SOVRAN™, and TunnelNet™. These names are designations developed under D3 Dynasty Holdings Inc. and are included for clarity and system mapping purposes only. Their inclusion does not limit the scope of the invention or claims described.

The system 200 is formally assigned to D3 Dynasty Holdings Inc., governed under the T-97 Legacy Instrument (revocable trust), which serves as the holding vehicle for all associated intellectual property, trademarks, and derivative works. This will ensure that everything is properly tied back to the company and trust structure.

The following names are trademarks of D3 Dynasty Holdings Inc. and are used herein for internal reference and system mapping ScrollCommand™, Snap+Log™, Vault Terminal™, REEDS™, SOVRAN™, TunnelNet™, and ClearRoute.AI™. These trademarks are not intended to limit the scope of the claims but provide clarity to the system architecture.

Various embodiments of the disclosure, as discussed above, may be practiced with steps and/or operations in a different order, and/or with hardware elements in configurations, which are different than those which, are disclosed. Therefore, although the disclosure has been described based on these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
receiving, by a system, a command packet transmitted from at least one authorized command source via a communication channel;
authenticating, by the system, the command packet and a set of authentication parameters associated with the command packet based at least on validating an authentication identifier associated with the command packet using a public key infrastructure defined for the command packet;
upon successful authentication of the command packet and the set of authentication parameters, determining, by the system, a priority level of the command packet received from each authorized command source of the at least one authorized command source based on a predefined hierarchy of issuing authorities;
facilitating, by the system, execution of at least one vehicular control action associated with the command packet associated with each authorized command source based at least on the determined priority level of the each authorization source, wherein the at least one vehicular control action is executed by a vehicle equipped with the system;
generating, by the system, a compliance log comprising a cryptographic record of the determined priority level, the at least one vehicular control action, the set of authentication parameters, vehicle response, and contextual telemetry; and
storing, by the system, the compliance log in a database associated with the system.

2. The computer-implemented method as claimed in claim 1, wherein authenticating the set of authentication parameters of each command packet comprises:
verifying, by the system, whether the command packet is received within a predefined time window based at least on a timestamp of the command packet;
verifying, by the system, an authorization certificate associated with the at least one authorized command source based at least on an authorized registry stored in the database associated with the system; and
verifying, by the system, geographic relevance of the at least one authorized command source.

3. The computer-implemented method as claimed in claim 1, further comprising:
assigning, by the system, a priority value for the command packet received from each authorized command source of the at least one authorized command source based at least on the predefined hierarchy of issuing authorities; and
determining, by the system, the priority level of the at least one authorized command source based at least on the priority value assigned to the command packet of each of the at least one authorized command source and a timestamp of the receipt of the at least one authorized command source.

4. The computer-implemented method as claimed in claim 1, wherein the at least one vehicular control action comprises:
adjusting a speed parameter of the vehicle;
initiating a lateral maneuver comprising a lane change, lane yield, or road shoulder pull-over;
overriding a navigation system associated with the vehicle to initiate a rerouting path in accordance with regional restrictions or evacuation corridors;
activating indicators associated with the vehicle to signal compliance status of the vehicle to other vehicles or pedestrians in proximity;
transmitting a compliance acknowledgment to the other vehicles in proximity using a vehicle-to-vehicle (V2V) communication protocol or to the at least one authorized command source; and
logging an executed vehicular control action of the at least one vehicular control action and associated telemetry as a compliance record.

5. The computer-implemented method as claimed in claim 1, further comprising:
upon successful authentication, determining, by the system, whether the command packet is classified as at least one of a low-priority category and a non-emergency category based on the priority level of the command packet received from at least one authorized command source;
facilitating, by the system, contextual verification of the command packet based on at least on one or more contextual parameters; and
configuring, by the system, a delay in execution of the command packet for a predefined buffer period to validate the command packet based at least on the receipt of a confirmatory message from other vehicles in the proximity via vehicle-to-vehicle (V2V) communication protocol.

6. The computer-implemented method as claimed in claim 1, further comprising:
detecting, by the system, a connectivity failure between an authorized command source of the at least one authorized command source during execution of a previously authenticated command packet of the authorized command source;
activating, by the system, a fail-safe mode in response to detecting the connectivity failure;
creating, by the system, a log of the connectivity failure in the database associated with the system during execution of the previously authenticated command packet of the authorized command source;
broadcasting, by the system, an emergency status associated with the vehicle to other vehicles in proximity via a vehicle-to-vehicle (V2V) communication protocol in response to activating the fail-safe mode; and
executing, by the system, at least one fail-safe operation in the vehicle upon broadcasting the emergency status of the vehicle to the other vehicles in proximity, wherein the at least one fail-safe operation is defined for the fail-safe mode.

7. The computer-implemented method as claimed in claim 6, further comprising executing, by the system, an emergency operation in the vehicle in response to detection of the connectivity failure, wherein the fail-safe mode is activated in the vehicle upon executing the emergency operation.

8. The computer-implemented method as claimed in claim 6, further comprising:
facilitating, by the system, a re-verification of the previously authenticated command packet using a public key infrastructure within a predefined time interval; and
activating, by the system, an override lockout mode in the vehicle to temporarily suspend subsequent command packet authentication upon failure to reverify the previously authenticated command packet within the predefined time interval.

9. The computer-implemented method as claimed in claim 1, further comprising:
determining, by the system, whether the command packet received from the at least one authorized source is related to an emergency priority;
determining, by the system, whether the command packet related to the emergency priority applies to a current location and route context associated with the vehicle;
generating, by the system, a route confirmation message indicating successful interpretation of the command packet to the current location and the route context; and
facilitating, by the system, execution of the at least one vehicular control action associated with the command packet based at least on the route confirmation message.

10. The computer-implemented method as claimed in claim 9, further comprising:
determining, by the system, whether the vehicle is operating in a fleet mode with other vehicles in response to determining the command packet related to the emergency priority applies to the current location and the route context associated with the vehicle; and
transmitting, by the system, the route confirmation message indicating successful interpretation of the command packet to the current location and the route context.

11. The computer-implemented method as claimed in claim 1, further comprising:
storing, by the system, the compliance log in at least one of a cloud infrastructure and a blockchain ledger communicably coupled to the system, wherein the compliance log is hashed using a cryptographic key associated with the vehicle; and
providing, by the system, access to the compliance log stored in at least one of the cloud infrastructure, the database associated with the system, and the blockchain ledger to the at least one authorized command source to perform verification of the compliance log.

12. The computer-implemented method as claimed in claim 1, wherein at least one authorized command source comprises military command centers, federal or state law enforcement agencies, emergency response organizations, municipal police departments, and civilian or insurance-related entities.

13. A system, comprising:
a communication interface;
a memory comprising executable instructions; and
a processor communicably coupled to the communication interface and the memory, the processor configured to cause the system to at least:
receive a command packet transmitted from at least one authorized command source via a communication channel,
authenticate the command packet and a set of authentication parameters associated with the command packet based at least on validating an authentication identifier associated with the command packet using a public key infrastructure defined for the command packet,
upon successful authentication of the command packet and the set of authentication parameters, determine a priority level of the command packet received from each authorized command source of the at least one authorized command source based on a predefined hierarchy of issuing authorities,
facilitate execution of at least one vehicular control action associated with the command packet associated with each authorized command source based at least on the determined priority level of the each authorization source, wherein the at least one vehicular control action is executed by a vehicle equipped with the system,
generate a compliance log comprising a cryptographic record of the determined priority level, the at least one vehicular control action, the set of authentication parameters, vehicle response, and contextual telemetry, and
store the compliance log in a database associated with the system.

14. The system as claimed in claim 13, wherein authenticating the set of authentication parameters of each command packet comprises:
verify whether the command packet is received within a predefined time window based at least on a timestamp of the command packet;
verify an authorization certificate associated with the at least one authorized command source based at least on an authorized registry stored in the database associated with the system; and
verify geographic relevance of the at least one authorized command source.

15. The system as claimed in claim 13, wherein the system is further caused, at least in part to:
assign a priority value for the command packet received from each authorized command source of the at least one authorized command source based at least on the predefined hierarchy of issuing authorities; and
determine the priority level of the at least one authorized command source based at least on the priority value assigned to the command packet of each of the at least one authorized command source and a timestamp of the receipt of the at least one authorized command source.

16. The system as claimed in claim 13, wherein the at least one vehicular control action comprises:
adjust a speed parameter of the vehicle;
initiate a lateral maneuver comprising a lane change, lane yield, or road shoulder pull-over;
override a navigation system associated with the vehicle to initiate a rerouting path in accordance with regional restrictions or evacuation corridors;
activate indicators associated with the vehicle to signal compliance status of the vehicle to other vehicles or pedestrians in proximity;
transmit a compliance acknowledgment to the other vehicles in proximity using a vehicle-to-vehicle (V2V) communication protocol or to the at least one authorized command source; and
log an executed vehicular control action of the at least one vehicular control action and associated telemetry as a compliance record.

17. The system as claimed in claim 13, wherein the system is further caused, at least in part to:
upon successful authentication, determine, whether the command packet is classified as at least one of a low-priority category and a non-emergency category based on the priority level of the command packet received from at least one authorized command source;
facilitate contextual verification of the command packet based on at least on one or more contextual parameters; and
configure a delay in execution of the command packet for a predefined buffer period to validate the command packet based at least on the receipt of a confirmatory message from other vehicles in the proximity via vehicle-to-vehicle (V2V) communication protocol.

18. The system as claimed in claim 13, wherein the system is further caused, at least in part to:
detect a connectivity failure between an authorized command source of the at least one authorized command source during execution of a previously authenticated command packet of the authorized command source;
activate a fail-safe mode in response to detecting the connectivity failure;
create a log of the connectivity failure in the database associated with the system during execution of the previously authenticated command packet of the authorized command source;
broadcast an emergency status associated with the vehicle to other vehicles in proximity via a vehicle-to-vehicle (V2V) communication protocol in response to activating the fail-safe mode; and
execute at least one fail-safe operation in the vehicle upon broadcasting the emergency status of the vehicle to the other vehicles in proximity, wherein the at least one fail-safe operation is defined for the fail-safe mode.

19. The system as claimed in claim 18, wherein the system is further caused, at least in part to execute an emergency operation in the vehicle in response to detection of the connectivity failure, wherein the fail-safe mode is activated in the vehicle upon executing the emergency operation.

20. The system as claimed in claim 18, wherein the system is further caused, at least in part to:
facilitate a re-verification of the previously authenticated command packet using a public key infrastructure within a predefined time interval; and
activate an override lockout mode in the vehicle to temporarily suspend subsequent command packet authentication upon failure to reverify the previously authenticated command packet within the predefined time interval.

21. The system as claimed in claim 13, wherein the system is further caused, at least in part to:
determine whether the command packet received from the at least one authorized source is related to an emergency priority;
determine whether the command packet related to the emergency priority applies to a current location and route context associated with the vehicle;
generate a route confirmation message indicating successful interpretation of the command packet to the current location and the route context; and
facilitate execution of the at least one vehicular control action associated with the command packet based at least on the route confirmation message.

22. The system as claimed in claim 21, wherein the system is further caused, at least in part to:
determine whether the vehicle is operating in a fleet mode with other vehicles in response to determining the command packet related to the emergency priority applies to the current location and the route context associated with the vehicle; and
transmit the route confirmation message indicating successful interpretation of the command packet to the current location and the route context.

23. The system as claimed in claim 13, wherein the system is further caused, at least in part to:
store the compliance log in at least one of a cloud infrastructure and a blockchain ledger communicably coupled to the system, wherein the compliance log is hashed using a cryptographic key associated with the vehicle; and
provide access to the compliance log stored in at least one of the cloud infrastructure, the database associated with the system, and the blockchain ledger to the at least one authorized command source to perform verification of the compliance log.

24. The system as claimed in claim 13, wherein at least one authorized command source comprises military command centers, federal or state law enforcement agencies, emergency response organizations, municipal police departments, and civilian or insurance-related entities.
